(19) United States
(12) Patent Application Publication
(10) Pub. No.: US 2016/0114541 A1
(43) Pub. Date: Apr. 28, 2016

(54) PROCESS AND APPARATUS FOR BORDERING A CORRUGATED PLASTIC PANEL AND PANEL THUS OBTAINED

(71) Applicant: K-HOLDING S.p.A., Sacile (IT)

(72) Inventors: Franco BRESSAN, Sacile (IT); Mirco DE NARDI, Sacile (IT)

(73) Assignee: K-HOLDING S.p.A., Sacile (IT)

(21) Appl. No.: 14/891,775

(22) PCT Filed: Apr. 18, 2014
(86) PCT No.: PCT/IB2014/060836

§ 371 Date: Nov. 17, 2015

(30) Foreign Application Priority Data
May 17, 2013 (IT) PN2013A000027

(51) Int. Cl. B29C 70/76; B29C 47/02; B29C 47/36; B29C 70/74; B29C 47/92

(52) U.S. Cl. CPC B29C 70/76; B29C 70/745; B29C 47/92; B29C 47/36; B29C 47/026; B29C 2947/92019; B29K 2101/12

(57) ABSTRACT

The present invention is related to a process for bordering a corrugated plastic panel and to a panel obtained through that process. In particular, the invention is related to a process for making a corrugated plastic panel comprising a bordering made in-line or out-line in order to close the openings outwards. The invention is also related to an apparatus for bordering according to that process. The panel is sealed and shock resistant thanks to the laying of thermoplastic elastomeric material.

### TECHNICAL FIELD OF THE INVENTION

The present invention is related to a process for bordering a corrugated plastic panel and to a panel obtained by means of such process. In particular, the invention is related to a process for the production of a corrugated plastic material panel comprising a bordering made in-line or off-line in order to close the openings towards the exterior. The invention is also related to an apparatus for bordering according to such process.

### PRIOR ART TECHNIQUE

In the packaging sector, plywood is a material still used nowadays as a separator in the pallet, while cardboard is used to separate single items. However, both these materials have a limited use because of their easy deterioration. In fact, both the plywood fibers and those of the cardboard tend to easily deteriorate when exposed to environmental conditions such as humidity, wind, rain or sun. Moreover, such materials are likewise easily contaminated because they are subject to dirt, fungi spores, and bacteria. As a result they are not well accepted especially in the sector of foodstuffs.

These inconveniences are overcome by the use of honeycomb or corrugated plastic panels as they have a very good resistance compared to their reduced weight, greater insulating properties and production inexpensiveness. In general, corrugated panels can be produced from thermoplastic polyolefin which gives, besides the above said advantages, also waterproof qualities and resistance to chemical agents. Further, they can economically be recycled and reused in the same packaging sector such as retaining flaps and interlayers or for separating items, or containers in general, boxes, molded panels, car interior components, walls, supports in general and other similar applications.

Typically corrugated plastic panels comprise a couple of thermoplastic sheets parallel and connected one to the other by means of longitudinal beams. The beams, then, form corrugations or divided longitudinal spaces which cover the whole length or width of the panel. Therefore, the panels are open along one or more of its borders, according to the profile and dimension of the corrugations.

The openings are a problem as they let in dust, dirt and liquids that accumulate in the corrugations. Further, the opening borders are rough and sharp so they can cause scratches to the user or tears to clothes. It is therefore necessary to close the openings, on the one hand, in order to prevent the dirt and liquid entrance and accumulation and on the other hand to avoid sharp borders.

To such purpose, there are mainly two ways to seal the perimetric borders of corrugated plastic panels. The first one consists in gluing a strip of the identical plastic material or similar to the one forming the panel on the profile delimiting the open corrugation. However, this process is rather complex because it is necessary to have a strip whereon some glue must be put and to have an adhering system for the strip thus prepared on the open corrugation. Further, the strip hold is rather low. The second way, more common, consists in heating the two parallel layers which make up the panel, in bending them in a reciprocal approach so as to put the respective free borders into contact and seal them. This process, though simpler and more efficient than the first one, requires the use of rather complex apparatuses. Moreover, the sealed border does not ensure a good shock resistance and, consequently, it is subject to easy breaking and to the same previously highlighted problems concerning open borders. A variation to that process consists in folding one of the two layers onto the other in order to increase the shock resistance and cover the border obtained in this way with a further layer of polymeric material or other bordering material. However, it is clear that such variation is particularly complex and expensive both for the process and for the finished product.

### SUMMARY OF THE INVENTION

The problem at the base of the present invention is that of providing a process for bordering a plastic corrugated panel which is simple and efficient so as to obtain a sealed panel and resistant at the borders.

Such problem is solved by means of a process comprising a step for sealing the open corrugations in correspondence with the borders through a single operation which allows to make a smooth and shock absorbing border.

Therefore a first object of the present invention is that of providing a bordering process of a corrugated plastic panel through material laying.

A second object is a corrugated thermoplastic panel sealed along its perimetric border through smooth and shockproof sealing.

A third object is a sealed corrugated thermoplastic panel and with a shaped or finished border.

A fourth object is that of providing a shaped elastic joint, with a hinge effect, between two thermoplastic panels or the union between two borders of the same sheet, in this case in order to close, seal the sheet onto itself.

A further object of the invention is an apparatus for bordering said corrugated thermoplastic panel so as to seal it.

Another further object is a plant for making a corrugated thermoplastic panel comprising said bordering apparatus.

### BRIEF DESCRIPTION OF FIGURES

Further characteristics and advantages of the process, panel and apparatus of the invention will become more apparent from the following description of a form of embodiment given for exemplification only but not limited to, with reference to the following figures, wherein:

FIG. 1 shows a schematic axonometric view of an apparatus for bordering a corrugated thermoplastic panel;

FIGS. 2A-2F show a view of a particular of the apparatus of FIG. 1 in different operating steps;

FIG. 3 shows an axonometric view of a thermoplastic panel bordered according to the present invention;

FIG. 4 shows a sectional side view along line IV-IV of the panel of FIG. 3 and an enlarged particular;

FIG. 5 shows a first example of use of the panel according to the invention;

FIG. 6 shows a second example of use of the panel according to the invention;

FIG. 7 shows an axonometric view of a group of assembled panels according to the invention;

FIG. 8 shows a sectional side view along line VIII-VIII of the group of panels of FIG. 8 disassembled;

FIG. 9 shows a schematic axonometric view of a variation of the apparatus of FIG. 1.

### DETAILED DESCRIPTION OF THE INVENTION

The idea at the base of the present invention is that of making a corrugated panel whose borders are sealed by means of the laying of a material selected in order to ensure from one hand the tightness against dirt and liquids and from the other resistance to shocks.

Based on numerous experimental tests it has been observed that the laying of the material has to be carried out through a process and an apparatus having well determined working parameters.

In particular, the process for bordering a corrugated plastic panel according to the invention comprises the following steps in succession:
a) providing a corrugated plastic panel having at least on open border;
b) heating a thermoplastic elastomeric material till its fusion point;
c) heating at least a portion of said border;
d) extruding said fused thermoplastic elastomeric material;
e) laying said fused material by means of an extrusion die in correspondence of at least said portion of said heated border, wherein the laying step is carried out with at least an angle comprised between 4° and 45° with respect to the tangent to the laying point.

It is to keep in mind that in the present description terms such as “horizontal”, “vertical” are referred to the position and orientation that the devices of an apparatus for bordering panels normally have, that is position and orientation when in use. Similarly, the steps for the bordering process can have generic reference terms which anyway are to be meant as related to the normal realization conditions of the process. Similarly, the term “high resistance” to abrasion and to chemical agents is referred to values which usually identify a resistance to a high number of cycles or long duration, as known by the skilled in the field.

Step a) providing a corrugated plastic panel consists in supplying traditional corrugated plastic panels, preferably polypropylene of various longitudinal, cross and thickness dimensions. For example, panels can have a thickness of 3-5 mm with basic weights between 400 and 1500 gr/m², or between 7 and 20 mm with basic weights between 1500 and 4000 gr/m² and of standard dimensions for the packaging sector, such as 1200×1000 mm, 1200×800 mm, 1418×1120 mm.

Step b) consists in heating a thermoplastic material till its fusion point. Depending on the desired properties, it is used: thermoplastic elastomeric materials (TPE) among which thermoplastic polyolefin (TPO), thermoplastic styrene (TPS), or polyolefin plastics, in the specific case the same as that of the corrugated panel, polypropylene, high density polyethylene, polycarbonate. In particular, the selected materials are compounds of polyolefins, thermoplastic elastomers of styrene origin (TPS such as SBS, SEBS) or of polyolefin origin (TPE, TPO), which can be filled with mineral fillers or glass fibers to increase the resistance properties and stability. Preferably, the above mentioned filler material is an open-cell or more preferably closed-cell foamed material. The fusion temperatures of the above said materials are known to the skilled in the field and anyway they are comprised between 120-240° C.

Step c) takes place heating at least the portion of the border of the panel in correspondence of the laying point of the fused elastomeric material to such a temperature so as to make the border to be sealed malleable, that is capable to prepare the contact surface with the material in order to obtain a fusion seal of the two materials. In other words, the contact surface must be capable of melding with the filler material without forming tensions or swellings. To this purpose, the temperature is preferably comprised between 120° and 180° C. The heating is preferably carried out by means of a hot air jet.

The extrusion step d) preferably occurs at a pressure so as not to compromise the integrity of the employed polymer and sufficient in order to ensure a constant quantity of the material feeding the pump. This pressure is comprised between 30 bars and 80 bars, preferably between 50 bars and 80 bars.

The next step e) that is laying said extruded material is carried out with the lowest possible inclination; it is preferable not to exceed 45° with respect to the tangent of the point where the laying takes place in order to avoid problems connected to the flow and deposit of the filler material.

Preferably, the process also comprises a step of blocking the fluid material flow in correspondence of the nozzle or die. Advantageously, this step makes it possible to avoid burrs and ravels of the material when the process is not carried out in a continuous way.

Preferably, the process also comprises a transport step of the material from the extrusion to the injection. The transport step can occur through the contemporary heating of the material so as to keep it in a fluid state.

The just described operating steps are carried out by selecting well defined operating parameters so as to obtain the best fluidity for the laying of the above said thermoplastic elastomeric material. In fact, the fluidity has to be calibrated according to the material chosen among those previously specified, both in order to allow an easy injection without any discontinuities caused, for example, by clots or clogging of the die or nozzle, and prevent the too fluid material from dripping once laid. Anyway, such adjustments are easy for the skilled in the field that will make the normal calibrations so as to set the precise operating parameters within the above said intervals for each material.

The process can further comprise a final cooling and shaping step of the border. The cooling can be carried out through a thermoregulated die, air blowing and the shaping through cooled calibration or on cooled and shaped calibrators or on shaped and cooled rollers.

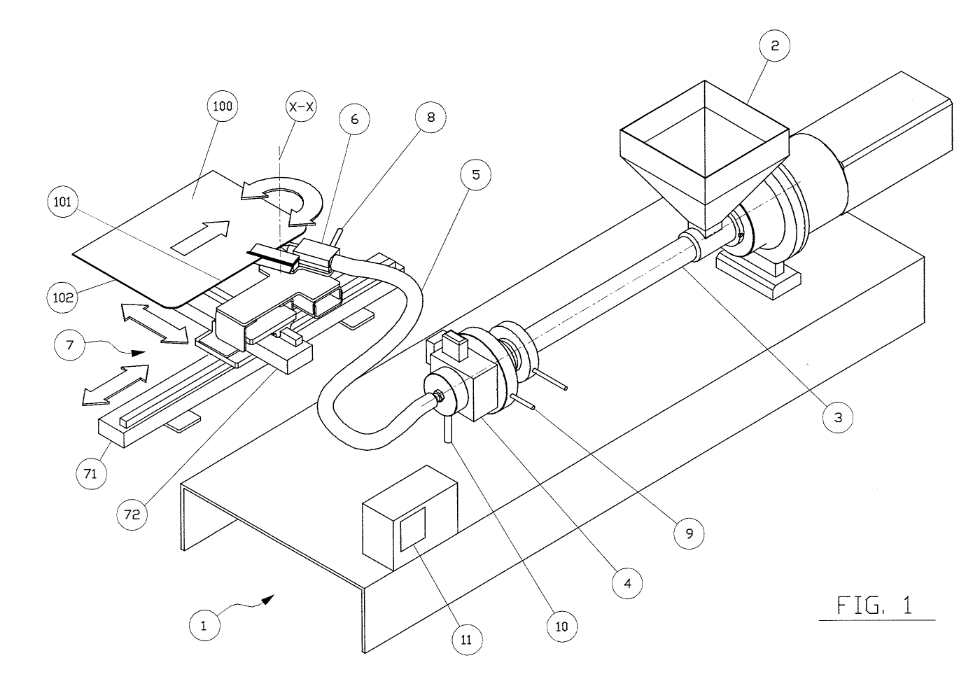

The just described process is preferably carried out by means of an apparatus as shown in FIG. 1. The apparatus, generally referred to as number 1, comprises a charging hopper 2 of the thermoplastic elastomeric material, an extruder 3, a metering pump 4, downstream the extruder, a flexible conduit 5, to transport the thermoplastic elastomeric material exiting the extruder, a die or a laying or injection nozzle of the thermoplastic elastomeric material 6, a moving system 7 of the die and a moving system of a corrugated panel to be sealed.

The hopper 2 is charged with the thermoplastic elastomeric material in the form of pellets. From the hopper the pellet falls into the feed portion of the extruder where it can be heated. Subsequently, the material goes into the extruder 3 which is made of a traditional cylinder inside which a worm screw presses the material. Thus, inside it, it occurs the transformation of the pellet from a solid state into a fused state due to the temperature and to the mechanical action of the compression and of the shearing stresses transmitted by the extrusion screw. Preferably, downstream the extruder, before the metering pump 4, there can be placed a pressure probe 9 apt at detecting the pressure entering the metering pump.

The metering pump 4, mounted at the end of the extruder 3, receives the fluid material and releases the amount necessary to continuously feed the die 6 depending on the characteristics of the border to be sealed, for example its thickness and therefore the space to be filled.

Preferably, after the pump and before the flexible conduit, there is a further probe 10 to detect the exit pressure of the same pump.

From the metering pump 4 it departs the flexible conduit 5 which transfers the fluid material to the die 6. The conduit must be flexible as it is connected to a moving die, as later described in detail. In particular, the conduit 5 must bear remarkable pressures, up to 150 bars, and temperatures up to 250° C. Consequently, it is made of a material with a high abrasion resistance and a high chemical resistance to all chemical substances, including acids and alkaline solutions of any concentration.

In particular, the flexible conduit is made of a PTFE smooth pipe intertwined with two layers of stainless steel wire, (1.4301) max., operating temperature of 250° C. and operating pressure up to 200 bars. Preferably, the conduit is equipped with heating elements. Moreover, the conduit is insulated by means of an insulating material, of the traditional kind, in order to prevent heat dispersion along the route from the pump to the die.

Preferably, a sensor 8 is mounted on the die 6 to detect the fluid pressure therein.

Then, it is provided a command and control unit 11 to regulate the pressure detected by the previously described probes.

The die 6 is made of a nozzle of any kind, or groups of nozzles or a plate provided with one or more holes calibrated so as to allow the desired profiling of the corrugated panel. Consequently, the die will be adapted according to the thickness and the shape of the border to be sealed.

In particular, in the case of the discontinuous process, the die 6 is mounted on a moving system 7 apt at moving the die along the open border of a panel so that it can always place itself, following its profile, with the same above said angle. The system 7 comprises respectively first 71 and second 72 guides or rails apt at moving the die 6 along respectively a first and second direction orthogonal to each other and laying on a horizontal plane. Further, the die is mounted in rotation on an orthogonal axis X-X, that is vertical, with respect to said first 71 and second 72 guides (FIG. 1). The moving system is also provided with sensors (not shown) apt at reading the die position with respect to the border profile so as to send a proximity signal to a command and control unit (not shown) of the movement of the same die.

It is to keep in mind that the movement of the die occurs according to pre-defined parameters loaded on a command and control unit (not shown) depending on the type of the panel to be sealed. In other words, the positioning and movement of the die 6 is carried out by means of the instructions sent to the command and control unit. The instructions are spatial coordinates stored in the command and control unit based on different types of panels.

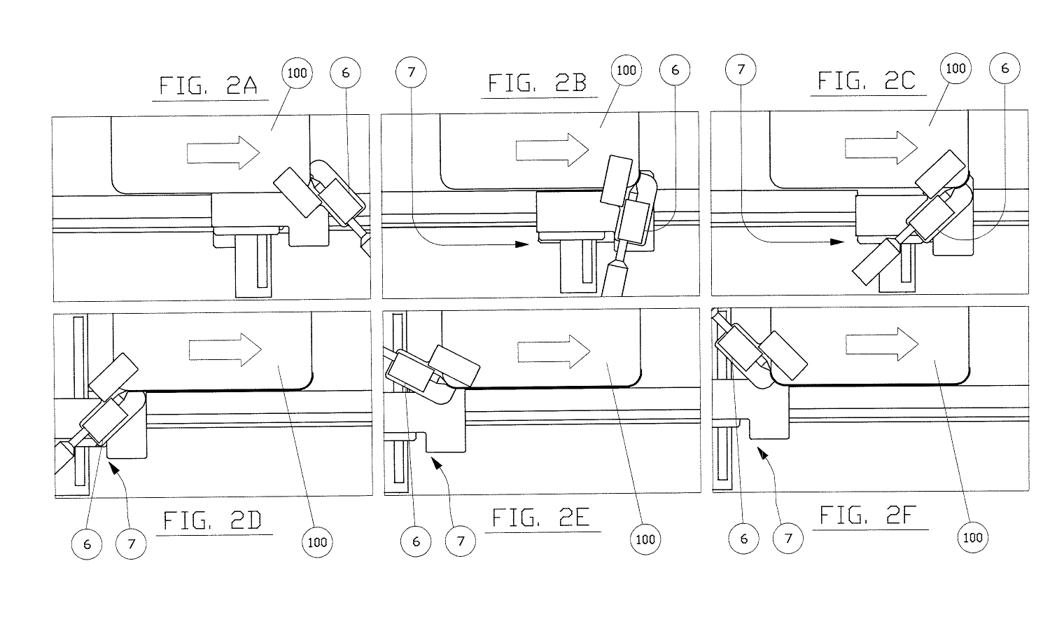

In FIG. 2A, it is shown a starting point of the laying step e) wherein the die 6 is in correspondence of a rounded corner of a panel 100 to be sealed. As previously described, once the program containing the instructions for a particular panel has been set (profile contour identified through the special coordinates, thickness, length of the sides and of the rounded corners), the moving system 7 is activated so as to follow the border profile of the panel 100 always keeping the correct angle of the die.

Therefore, with the die movement, as shown in figures from 2B to 2F, the system is capable of following, in a very precise way, the entire profile of the panel so as to place the die in the correct position at every moment and to allow the laying of the filler material to seal the openings.

The panel movement is carried out through continuous belt or chain or roller haul-off, in particular in the case of the continuous process the continuous sheet is moved by means of roller haul-offs. The movement of the sheet must be, both in the continuous and discontinuous cases, constant and synchronized with the laying speed and in the discontinuous case with the tracking system of the die. In this case, the sealing first occurs on two sides of the panel in the extrusion line or by means of a first transit in order to seal two or three adjacent sides, and two borders by means of the moving system previously described with reference to FIGS. 2A-2F. Then the sheet is turned by 180° and the other two adjacent sides or the remaining side are bordered with the respective borders.

Preferably, the die or nozzle 6 comprises a gate with a needle valve of the conventional type. In particular, the blocking of the canal occurs by means of a needle operated by a pneumatic piston: when the needle is pushed towards the nozzle or the exit channel of the material, it forms a conical seal with the channel walls blocking the flow, when it is lifted, the seal opens letting the material flow (not shown).

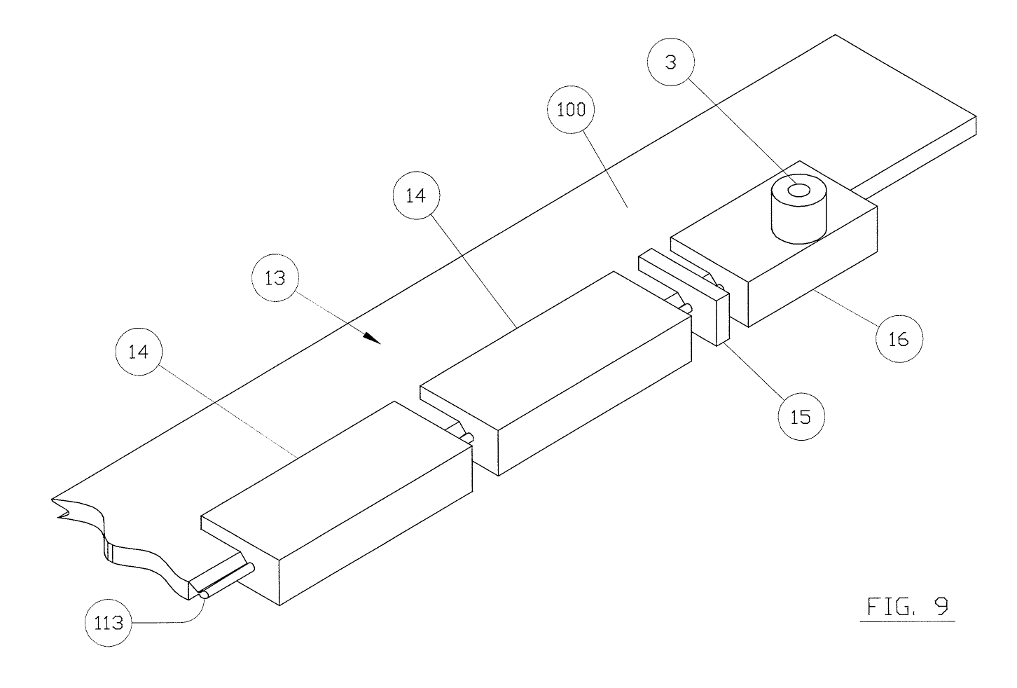

Preferably, moreover, the apparatus comprises a cooling-calibration group 13, as shown in FIG. 9. The calibration group, placed as close as possible to the die or nozzle is a counter mold of the profile to be made. The counter mold 14, or mold, is cooled, or better thermoregulated, by means of a command and control unit (not shown), and can also operate in a vacuum so that the extruded material can perfectly adhere to the calibrator and can cool down in a controlled way. In the simplest forms the counter mold 14 is formed by a series of rollers shaped as the resulting border, they too cooled down. Preferably, in order to ensure the entering into the cooling calibration group some air is insufflated by means of, for example, a traditional air knife nozzle 15 (schematically shown in FIG. 9) having the function of lowering the surface temperature of the filler material and of reducing the friction when entering the calibration group.

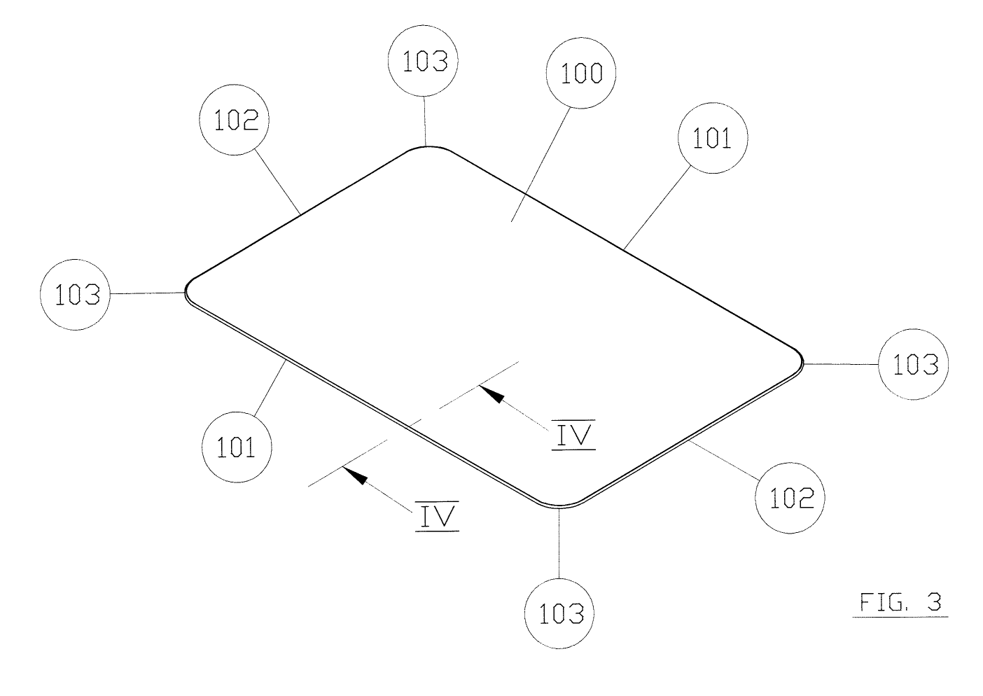

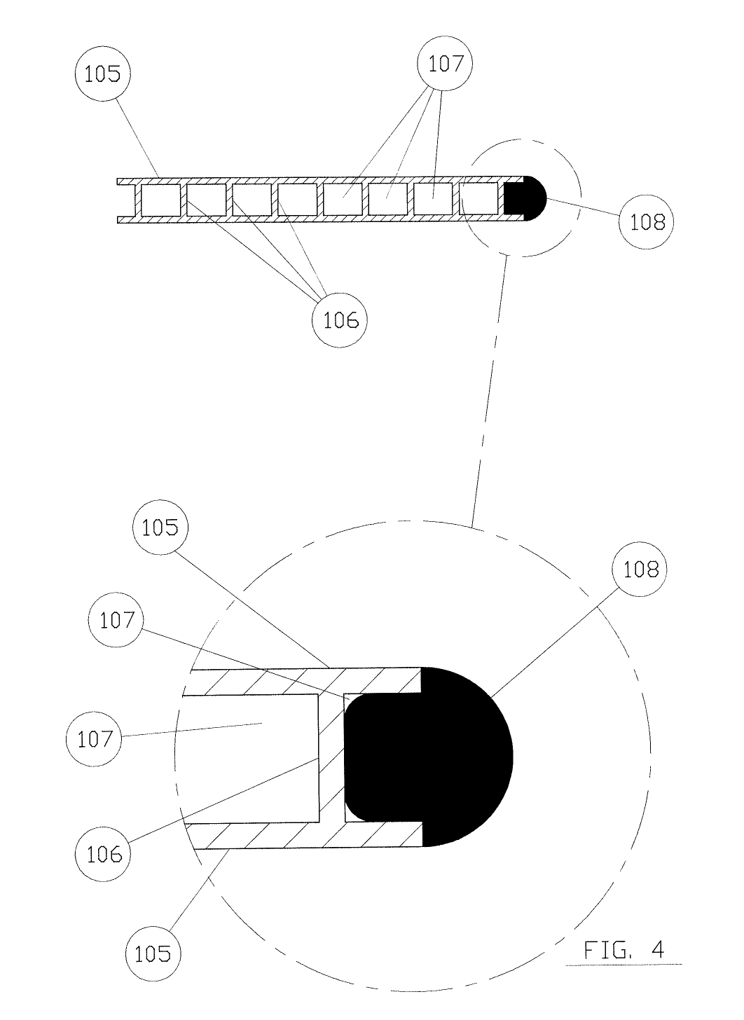

As shown in FIG. 3, a corrugated panel 100 according to the present invention comprises a border provided with two first sides 101, two second sides 102 and four rounded corners 103. The sealed panel 100 has, in a sectional view as shown in FIG. 4, two sheets parallel and spaced by corresponding inter-layers 106 so as to form corrugations 107.

Along the outer border of the panel, the corrugations 107 are closed, that is sealed, by means of laying thermoplastic elastomeric material 108. As it can be seen from the enlargement of FIG. 4, the material 108 fills at least partially the open corrugation and so its contact surface and that of the corrugation are sealed through fusion.

Further, advantageously, the thermoplastic elastomeric material of the bordering, thanks to the above said process, protrudes with respect to the profile of the panel so as to form a sort of protection against shocks. Consequently, the resulting bordering acts not only as a sealing for the corrugations, but also, thanks to the properties of the laid material, it absorbs the shocks in an efficient way.

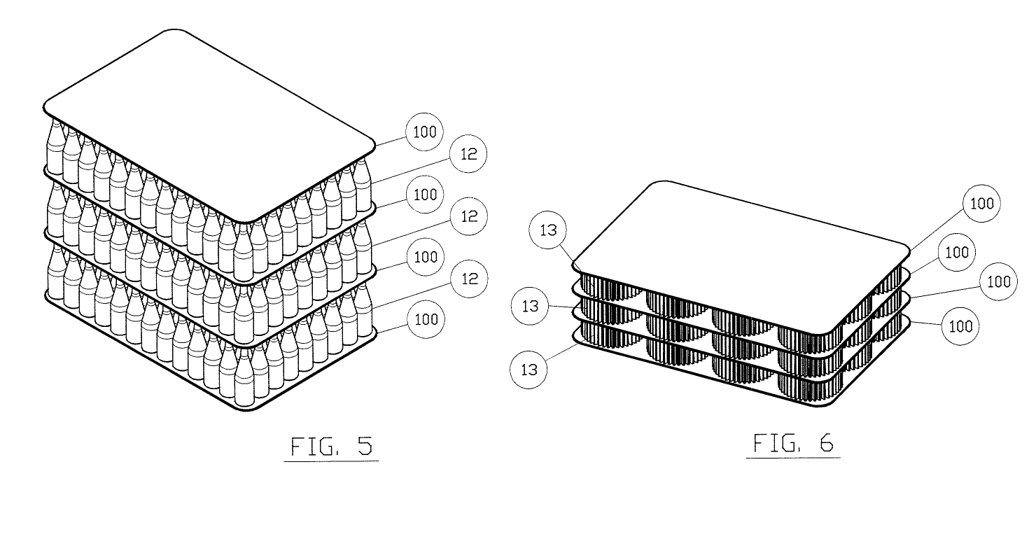

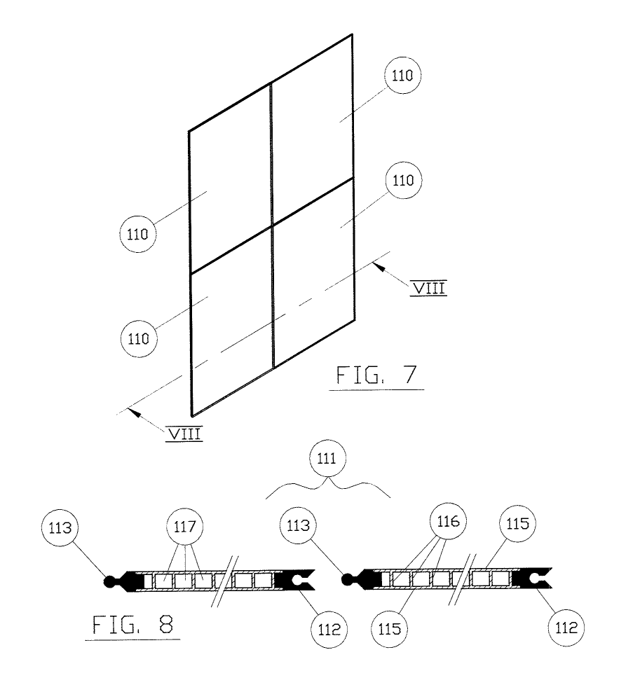

The panel 100, according to the present invention, has a great number of applications. For example, as shown in FIGS. 5 and 6 respectively, it can be used as an interlayer for separating and packaging food containers such as bottles 12, or to separate mechanical items such as gears 13, (shown in FIG. 6) molded items, etc.

It can further be used for boxes of various shapes and dimensions.

In particular with reference to a variation of embodiment of the invention as shown in FIGS. 7 and 8, panels 110 are basically identical to panel 100 previously described and comprise two parallel sheets 115 separated by interlayers 116 which define the corrugations 117. Advantageously, these panels can be assembled one with the other in order to form structures which can be assembled with single elements according to space requirements. Therefore, actually any requirements can be fulfilled with only one size. It is to note that the assembling can occur by interlocking of the perimetric borders 111 of adjacent panels 110. In fact, such borders 111 are provided with interlocking means. In other words, the borders 111 are provided with at least a first border 112 provided with a groove apt at receiving a corresponding protrusion of a second border 113. Preferably, the interlocking is snap-fitted and with shape coupling.

In order to achieve such particular bordering, it is possible to lay the material with die and immediately work the still malleable material with a calibration tool in order to obtain all the desired shapes. In other words, soon after the laying when the material is still workable, a tool provided with a counter mold gives the desired shape, be it simply rounded by means of rollers, be it groove and tongue joint with suitable counter mold, as shown in FIG. 9. Alternatively, the die can comprise a mold 16 wherein the thermoplastic polymeric material coming from the extruder 3 is laid. The mold will be already shaped so as to give the border the desired shape. As in the foregoing, such mold 16 will be moved along the borders of the panel 100 so as to achieve the bordering/sealing according to the invention.

From the foregoing, it is apparent that the above said problems have been solved and important advantages have been reached.

In fact, the corrugated panel comprises a leak-proof sealing thanks to the fusion sealing of the contact surface between the perimetric border of the panel and a thermoplastic elastomeric material laid through extrusion and injection. Hence, it is very effectively prevented dirt and liquid from entering that can cause mildew and bacteria growth which is absolutely to be prevented especially when used for packaging foodstuffs.

The resulting border is profiled; therefore it is possible to make particular shapes such as radial connections or interlocking with shape couplings.

The bordering gives a high resistance to shocks just at the portion of panels which is more subject to damages, also thanks, at least, to the partial filling of the open corrugations.

Moreover, even in case of breaking, it is easy to repair them as it is sufficient to inject anew an amount of material to form a new sealing or more simply to heat re-calibrate the border (manually as well).

The possibility of shaping or finishing the bordering makes it possible to have also an attractive aspect and avoid ruggedness or possible malformations.

A great number of variations to the process and apparatus of the invention can be carried out by the skilled in the field nevertheless without exiting the protection field as defined in the appended claims.

1. Process for bordering a corrugated plastic panel, comprising the following steps in succession:
a) providing a corrugated plastic panel having at least one perimetric open border;
b) heating a thermoplastic elastomeric material till its fusion point;
c) heating at least a portion of said border;
d) extruding said fused thermoplastic elastomeric material;
e) laying said fused material along all the perimetric border of said panel in order to fill at least partially the corrugations of the panel to seal them towards the exterior,
wherein the laying step is carried out with an angle less than 45° with respect to the tangent to the point of the laying.

2. Process according to claim 1, wherein step b) consists in fusing a thermoplastic elastomeric (TPE) material.

3. Process according to claim 2, wherein said thermoplastic elastomeric material is selected among compound of polyolefin, thermoplastic elastomers of styrene origin or of polyolefin origin.

4. Process according to claim 3, wherein said thermoplastic elastomeric material is an open-cell foamed material or closed-cell foamed material.

5. Process according to claim 1, wherein said step e) of laying of the extruded material is carried out with an inclination of 4°-45° with respect to the tangent to the laying point, and the exit pressure of the material is comprised between 20 bar and 140 bar.

6. Process according to claim 1, comprising a step of blocking of the fluid material flow in correspondence of the laying point.

7. Process according to claim 1, further comprising a final cooling and shaping step of the border so laid.

8. Apparatus for bordering a corrugated plastic panel, comprising an extruder for a thermoplastic elastomeric material, a die or nozzle to supply said material, a moving system of said die along respectively a first and a second directions orthogonal to each other and laying on an horizontal plane, and said die being rotated around an axis which is orthogonal, that is vertical, respect to said horizontal plane.

9. Apparatus according to claim 8, further comprising a metering pump downstream the extruder, a flexible conduit to transport the material metered by the pump to the die, a pressure probe downstream the extruder, a pressure pump downstream the pump and a pressure probe mounted onto the die or nozzle, a command and control unit of the fluid pressure and a command and control unit for moving the die.

10. Corrugated panel comprising a perimetric border having open corrugations externally sealed by means of thermoplastic elastomeric material laid in order to fill at least partially said corrugations and in order to externally protrude, the respective contact surfaces of the corrugations and of the laid material being fused.

11. Process according to claim 2, wherein the thermoplastic elastomeric (TPE) material is selected from the group consisting of: thermoplastic elastomers as thermoplastic polyolefin (TPO), thermoplastic styrene (TPS), or polyolefin plastics, polypropylene, high density polyethylene, polycarbonate.

12. Process according to claim 3, wherein the compound of polyolefin, thermoplastic elastomers of styrene origin are selected from the group consisting of: TPS, SBS, SEBS.

13. Process according to claim 3, wherein the compound of polyolefin, thermoplastic elastomers of polyolefin origin are selected from the group consisting of TPE and TPO.
